(19) United States
(12) Patent Application Publication
(10) Pub. No.: US 2025/0172768 A1
(43) Pub. Date: May 29, 2025

(54) ACTIVE OPTICAL CABLE

(71) Applicant: OPTICIS CO., LTD., Seongnam-si (KR)

(72) Inventors: Geun Han SONG, Namyangju-si, Gyeonggi-do (KR); Jong Ho LEE, Seongnam-si, Gyeonggi-do (KR); Jeong Beom YOON, Buk-gu, Gwangju (KR)

(21) Appl. No.: 18/605,299

(22) Filed: Mar. 14, 2024

(30) Foreign Application Priority Data
Nov. 28, 2023 (KR) 10-2023-0168455

(51) Int. Cl. G02B 6/42

(52) U.S. Cl. CPC G02B 6/4214

(57) ABSTRACT

An active optical cable includes a PCB portion connected to an optical cable portion, an optical engine coupled to the PCB portion, and a plurality of optical fibers extending from the optical cable portion, wherein the optical engine is connected to the plurality of optical fibers, and the plurality of optical fibers are inserted and combined inside the optical engine.

### CROSS-REFERENCE TO RELATED APPLICATION

This application is based on and claims priority under 35 U.S.C. § 119 to Korean Patent Application No. 10-2023-0168455, filed on Nov. 28, 2023, in the Korean Intellectual Property Office, the disclosure of which is incorporated by reference herein in its entirety.

### BACKGROUND

### 1. Field

The disclosure relates to an active optical cable.

### 2. Description of the Related Art

An active optical cable (AOC) may transmit data by converting optical signals into electrical signals or electrical signals into optical signals. The AOC enables high transmission speeds and long transmission distances.

A printed circuit board (PCB) portion forming the AOC may convert the optical signal of the optical cable portion into an electrical signal, may be electrically connected to electronic devices through a connector, and may transmit and receive data to and from electronic devices by transmitting and receiving electrical signals to and from the electronic devices.

The optical cable portion may be connected to the PCB portion through an optical fiber, and the optical fiber may transmit optical signals to the PCB portion. In this case, optical elements for receiving or emitting an optical signal may be formed in the PCB portion. The optical elements and optical fibers are vulnerable to external shocks and may be damaged by external physical shocks.

### SUMMARY

To solve the above problems, the present invention provides an active optical cable capable of protecting optical fibers and optical elements therein.

However, these problems are illustrative, and the problems to be solved by the present invention are not limited thereto.

Additional aspects will be set forth in part in the description which follows and, in part, will be apparent from the description, or may be learned by practice of the presented embodiments of the disclosure.

According to an aspect of the disclosure, an active optical cable includes a PCB portion connected to an optical cable portion, an optical engine coupled to the PCB portion, and a plurality of optical fibers extending from the optical cable portion, wherein the optical engine is connected to the plurality of optical fibers, and the plurality of optical fibers are inserted and combined inside the optical engine.

In the active optical cable according to an embodiment of the present invention, the optical engine is formed to cover an optical element formed on the PCB portion.

In the active optical cable according to an embodiment of the present invention, the optical engine includes a first lens that condenses light emitted from an optical element, a mirror-inclined plate that reflects light that passed through the first lens, and a second lens that condenses light reflected by the mirror-inclined plate.

In the active optical cable according to an embodiment of the present invention, the light condensed by the second lens passes through the optical fiber through an optical fiber end.

In the active optical cable according to an embodiment of the present invention, the mirror-inclined plate bends a path of light passing through the first lens by a 90-degree angle.

In the active optical cable according to an embodiment of the present invention, the optical engine includes an optical fiber connector connected to the plurality of optical fibers, and a main body coupled to the optical fiber connector, and the first lens and the second lens are disposed on the main body.

In the active optical cable according to an embodiment of the present invention, the optical engine includes an optical fiber connector connected to the plurality of optical fibers, and a main body coupled to the optical fiber connector, wherein a plurality of hole portions are formed in the optical fiber connector, the plurality of hole portions are arranged in a row in a first direction, and the second lenses are formed in plural numbers and arranged in a row at positions corresponding to each of the plurality of hole portions arranged in a row.

In the active optical cable according to an embodiment of the present invention, the plurality of second lenses are arranged in a row in the first direction, and the first lenses are formed in plural numbers and are arranged in a row at a position corresponding to each of the plurality of second lenses arranged in a row at an angle of 90 degrees with respect to the mirror-inclined plate.

In the active optical cable according to an embodiment of the present invention, the plurality of first lenses are arranged in a row in the first direction, an optical element is formed on the PCB portion, and the optical elements are formed in plural numbers and arranged in a row at positions corresponding to each of the plurality of first lenses arranged in a row.

In the active optical cable according to an embodiment of the present invention, a magnification ratio of the first lens to the second lens is 1:1 to 1:2.

In the active optical cable according to an embodiment of the present invention, the optical engine includes an optical fiber connector connected to the plurality of optical fibers, and a main body coupled to the optical fiber connector, a plurality of hole portions are formed in the optical fiber connector, the plurality of optical fibers pass through the plurality of hole portions and are connected to the optical fiber connector.

In the active optical cable according to an embodiment of the present invention, recessed portions are formed in the optical fiber connector, protruding portions are formed in the main body, and the protruding portions are respectively inserted in and coupled to the recessed portions.

In the active optical cable according to an embodiment of the present invention, the protruding portions are disposed on both sides of the plurality of holes with the plurality of holes positioned between the two protruding portions, the two recessed portions are disposed at positions corresponding to the protruding portions, and the two protruding portions are respectively inserted in and coupled to the two recessed portions.

In the active optical cable according to an embodiment of the present invention, an end of the protruding portion is formed in a hemispherical shape.

In the active optical cable according to an embodiment of the present invention, a pivot mark is formed at a lower end of the main body.

In the active optical cable according to an embodiment of the present invention, the PCB portion is connected to both ends of the optical cable portion, the optical engine is connected to both ends of the plurality of optical fibers, light emitted through an optical element of the PCB portion passes through one optical engine and passes from one end to the other end of the plurality of optical fibers, and light passing through the other end of the plurality of optical fibers passes through the other optical engine and is received through the optical element of the other PCB portion.

In the active optical cable according to an embodiment of the present invention, the light emitted through the optical element sequentially passes through a first lens, a mirror-inclined plate, and a second lens and is condensed on one end of the plurality of optical fibers.

In the active optical cable according to an embodiment of the present invention, the light condensed to one end of the plurality of optical fibers moves to the other end of the plurality of optical fibers, and the light moving to the other end of the plurality of optical fibers sequentially passes through the other second lens, the other mirror-inclined plate, and the other first lens and is received by the optical element of the other PCB portion.

Other aspects, features and advantages other than those described above are become apparent from the detailed description, claims and drawings for carrying out the invention below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an exploded perspective view showing an active optical cable according to an embodiment of the present invention.

FIG. 2 is a perspective view showing the assembled structure of an active optical cable according to an embodiment of the present invention.

FIG. 3 is an exploded perspective view showing an optical cable portion, an optical fiber connector, and a main body portion according to an embodiment of the present invention.

FIG. 4 is a diagram showing the internal structure of an optical engine according to an embodiment of the present invention.

FIG. 5 shows a cross-sectional view taken along line A-A′ of FIG. 4.

FIG. 6 is a diagram showing one optical engine and another optical engine formed at both ends of an optical cable portion according to an embodiment of the present invention.

FIG. 7 is a diagram showing a B-B′ cross section and C-C′ cross section of FIG. 6.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

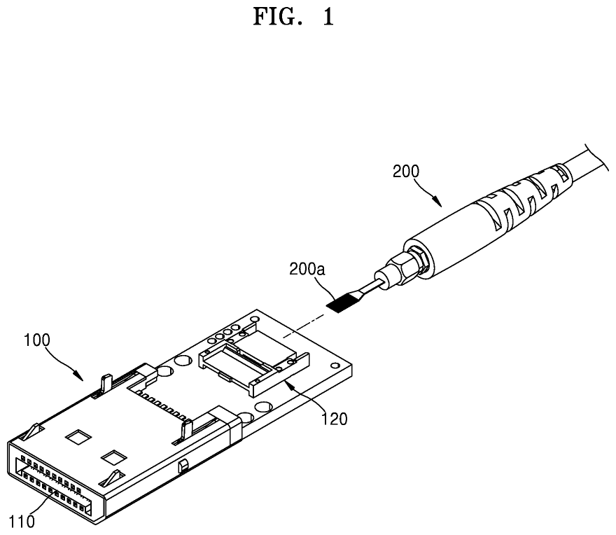

Hereinafter, an active optical cable according to an embodiment of the present invention is described with reference to FIGS. 1 to 5.

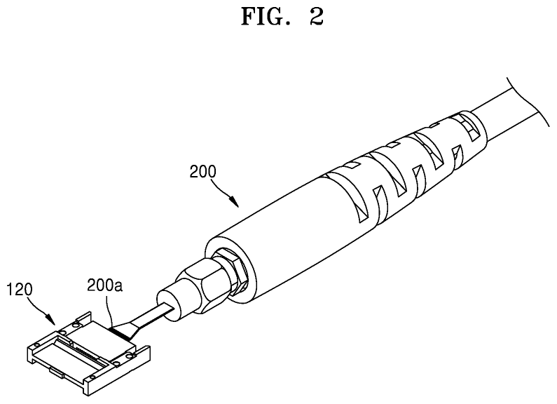

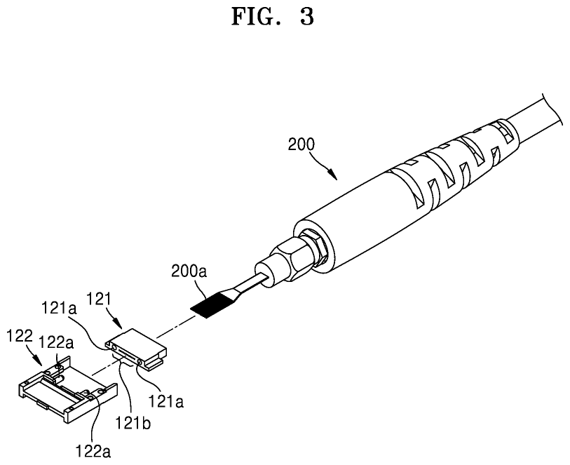

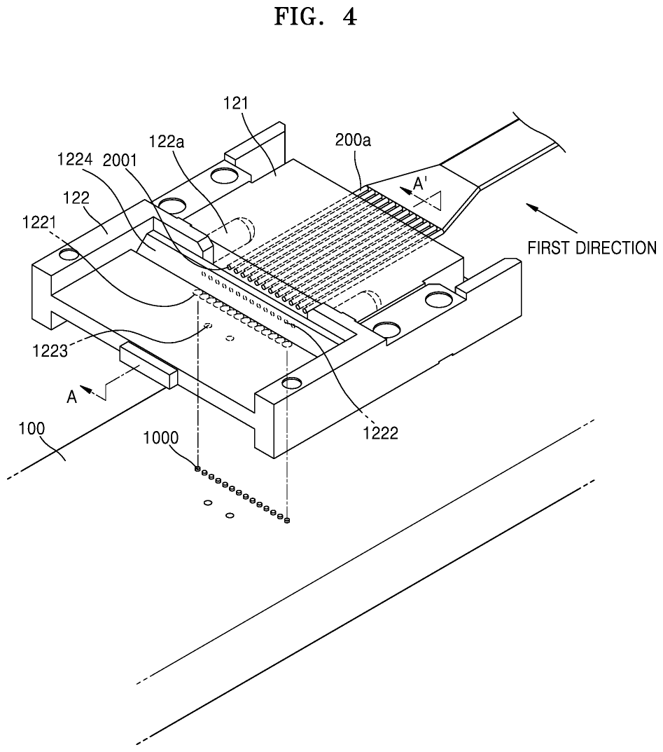

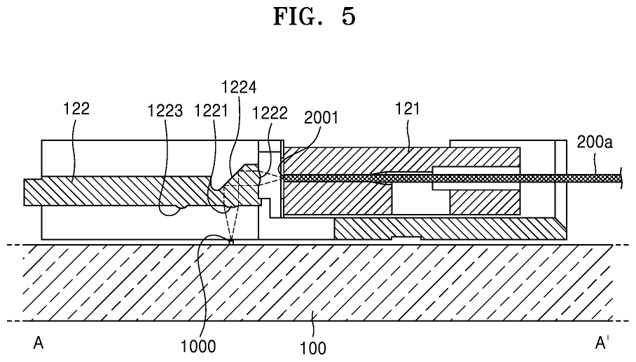

FIG. 1 is an exploded perspective view showing an active optical cable according to an embodiment of the present invention. FIG. 2 is a perspective view showing the assembled structure of an active optical cable according to an embodiment of the present invention. FIG. 3 is an exploded perspective view showing an optical cable portion, an optical fiber connector, and a main body portion according to an embodiment of the present invention. FIG. 4 is a diagram showing the internal structure of an optical engine according to an embodiment of the present invention. FIG. 5 shows a cross-sectional view taken along line A-A′ of FIG. 4.

Referring to FIGS. 1 to 5, an active optical cable according to an embodiment of the present invention includes a PCB portion 100 connected to an optical cable portion 200, an optical engine 120 coupled to the PCB portion 100, and a plurality of optical fibers 200a extending from the optical cable portion 200. The optical engine 120 is connected to the plurality of optical fibers 200a, and the plurality of optical fibers 200a are inserted and coupled to the inside of the optical engine 120.

The PCB portion 100 may include a connector 110 coupled to external electrical equipment and an optical engine 120 coupled to the optical cable portion 200. In this case, the optical cable portion 200 includes an optical fiber connector 121 connected to the optical fiber 200a, and the optical fiber connector 121 may be coupled to a main body 122 of the optical engine 120.

The PCB portion 100 may convert an optical signal of the optical cable portion 200 into an electrical signal and transmit data to an electrical device connected to the PCB portion 100 through the connector 110 using the electrical signal. In this case, the optical cable portion 200 may include the optical fiber 200a. The optical fiber 200a may be connected to the optical engine 120 of the PCB portion 100. With this configuration, the optical signal transmitted through the optical fiber 200a may be transmitted to the PCB portion 100 through the optical engine 120.

The PCB portion 100 may transmit data to an external electrical device by converting an optical signal into an electrical signal and transmitting the electrical signal to the external electrical device. In this embodiment, only the PCB portion 100 formed on one end of the optical cable portion 200 has been described, but the PCB portion may be formed on both ends of the optical cable portion 200, respectively.

The plurality of optical fibers 200a may be inserted and coupled into the optical engine 120. In more detail, the optical engine 120 may include the optical fiber connector 121 connected to a plurality of optical fibers 200a and the main body 122 coupled to the optical fiber connector 121. In this case, a plurality of hole portions 121b may be formed in the fiber connector 121, and a plurality of optical fibers 200a may pass through the plurality of hole portions 121b and be connected to the optical fiber connector 121. That is, because the plurality of optical fibers 200a are connected to the optical engine 120 by being inserted and coupled inside the plurality of hole portions 121b penetrating the inside of the optical fiber connector 121, the plurality of optical fibers 200a may be protected by the optical fiber connector 121 in the event of external physical shock, thereby ensuring the durability and quality of the product.

In addition, the optical engine 120 may be formed to cover an optical element 1000 formed on the PCB portion 100. With this configuration, the optical device 1000 can be protected by preventing damage from external physical shock, thereby ensuring the durability and quality of the product.

According to this embodiment, a recessed portion 121a may be formed in the optical fiber connector 121, and a protruding portion 122a may be formed in the main body 122. The protruding portion 122a may be inserted and coupled to the recessed portion 121a. With this configuration, a coupling strength between the main body 122 and the optical fiber connector 121 may be improved. In addition, by combining the protruding portion 122a with the recessed portion 121a, positional errors that may occur when combining the main body 122 with the optical fiber connector 121 are minimized, so that a second lens 1222 of the main body 122, which is described below, and an optical fiber end 2001 of the optical fiber connector 121 are precisely placed at corresponding positions to form a path for light to move, and when the light moves, the light may be moved between the second lens 1222 and the end of an optical fiber without deviating from the path. In addition, durability may be ensured so that the corresponding arrangement position between the second lens 1222 of the main body 122 and the optical fiber end 2001 of the optical fiber connector 121 does not change through the coupling structure between the protruding portion 122a and the recessed portion 121a despite external physical shock.

According to this embodiment, the protruding portions 122a are disposed on both sides of the plurality of hole portions 121b, and the plurality of hole portions 121b are located between the two protruding portions 122a. Two recessed portions 121a are disposed at positions corresponding to the protruding portions 122a, and the two protruding portions 122a have a structure in which the two protruding portions 122a are respectively inserted and coupled to the two recessed portions 121a. Through this arrangement and coupling structure, without interfering with the path of light between the second lens 1222 of the main body 122 and the optical fiber end 2001 of the optical fiber connector 121, the protruding portions 122a and the recessed portions 121a are arranged on both sides of the light path to form a symmetrical coupling structure on both sides of the light path. Thereby, the light traveling between the second lens 1222 of the main body 121 and the optical fiber end 2001 of the optical fiber connector 121 is not interrupted by the coupling structure, and at the same time, the second lens 1222 of the main body 122 and the optical fiber end 2001 of the optical fiber connector 121 may be precisely placed at positions corresponding to each other.

In addition, because the coupling structure between the protruding portions 122a and the recessed portions 121a is disposed on both sides of the corresponding position between the second lens 1222 of the main body 122 and the optical fiber end 2001 of the optical fiber connector 121, durability may be further secured so that the corresponding arrangement position between the second lens 1222 of the main body 122 and the optical fiber end 2001 of the optical fiber connector 121 does not change through the coupling structure between the protruding portions 122a and the recessed portions 121a despite external physical shock.

According to this embodiment, an end of the protruding portion 122a is formed in a hemispherical shape, and the recessed portion of the recessed portion 121a is also recessed to correspond to the hemispherical shape. Through the shapes of the protruding portion 122a and the recessed portion 121a, when the protruding portion 122a is coupled into the recessed portion 121a, an end edge of the protruding portion 122a is tapered, so that the protruding portion 122a may enter the recessed portion 121a more naturally.

According to this embodiment, a pivot mark 1223 may be formed at the lower end of the main body 122. By recognizing the position of the pivot mark through vision to combine the optical engine 120 with the PCB portion 100, the optical engine 120 may be coupled to the PCB portion 100 with the optical element 1000 and the first lens 1221 aligned by precisely adjusting the arrangement position between the optical element 1000 and the first lens 1221 so that the arrangement positions between the optical element 1000 and the first lens 1221 correspond to each other. Thereby, light moving through the optical element 1000 and the first lens 1221 may be prevented from deviating from the movement path thereof.

According to this embodiment, the number of optical fibers 200a is shown as 12, but the number of optical fibers 200a is not limited thereto. The number of second lenses 1222, first lenses 1221, and optical elements 1000 corresponding to the optical fiber 200a may be greater than or equal to the number of optical fibers 200a. In this embodiment, the number of second lenses 1222, first lenses 1221, and optical elements 1000 corresponding to the optical fiber 200a is 14, but the number of second lenses 1222, first lenses 1221, and optical elements 1000 is sufficient to be 12 or more when the number of optical fibers 200a is 12. This means that by preparing a reserve in advance for the optical path passing through the optical fiber 200a, a corresponding optical path may be provided when the number of optical fibers 200a increases.

According to this embodiment, the optical engine 120 may include a first lens 1221 for condensing light emitted from an optical element 1000, a mirror-inclined plate 1224 for reflecting light passing through the first lens 1221, and a second lens 1222 for condensing light reflected through the mirror-inclined plate 1224. In this case, the light condensed by the second lens 1222 may pass through the optical fiber 200a through the optical fiber end 2001.

The first lens 1221 and the second lens 1222 of the optical engine 120 may be disposed on the main body 122. In addition, the mirror-inclined plate 1224 may bend the path of light passing through the first lens 1221 by a 90-degree angle.

The first lens 1221 may include an aspherical lens. The first lens 1221 may serve to collect light emitted from the optical element 1000. The light collected by the first lens 1221 may be reflected through the mirror-inclined plate 1224. The mirror-inclined plate 1224 may serve to change the direction of light travel in the vertical direction. Through this configuration and function, the direction of light is bent once, and the optical engine may be formed to have thickness only up to the point where the light is bent, making it possible to manufacture an optical engine with a slimmer thickness.

The second lens 1222 may serve to once again collect light bent by 90 degrees through the mirror-inclined plate 1224. The light collected through the second lens 1222 may pass through the optical fiber end 2001 and inside the optical fiber 200a.

According to this embodiment, the magnification ratio of the first lens 1221 to the second lens 1222 may be 1:1 to 1:1.9. The 1:1 magnification ratio may be used in a structure in which the optical element 1000 is used as both a light emitting portion and a light receiving portion. In this case, the 1:1 magnification ratio may be the ideal design ratio. The 1:1.9 magnification ratio may reflect assembly tolerances and equipment tolerances during mass production of actual lenses, which may be a structure that improves assembly.

According to this embodiment, the plurality of hole portions 121b are formed in the optical fiber connector 121, the plurality of hole portions 121b are arranged in a row in a first direction, and the second lenses 1222 may be formed in plural numbers and arranged in a row at positions corresponding to each of the plurality of hole portions 121b arranged in a row.

In this case, the plurality of second lenses 1222 are arranged in a row in the first direction, and the first lenses 1221 may be formed in plural numbers and may be arranged in a row at a position corresponding to each of the plurality of second lenses 1222 arranged in a row at an angle of 90 degrees with respect to the mirror-inclined plate 1224.

In addition, the plurality of first lenses 1221 may be arranged in a row in the first direction, and an optical element 1000 may be formed on the PCB portion 100, and the plurality of optical elements may be formed and arranged in a row at positions corresponding to each of the plurality of first lenses 1221 arranged in a row.

In this way, a plurality of optical signals may be transmitted through a plurality of light paths passing through the plurality of optical fibers 200a and the plurality of optical elements 1000.

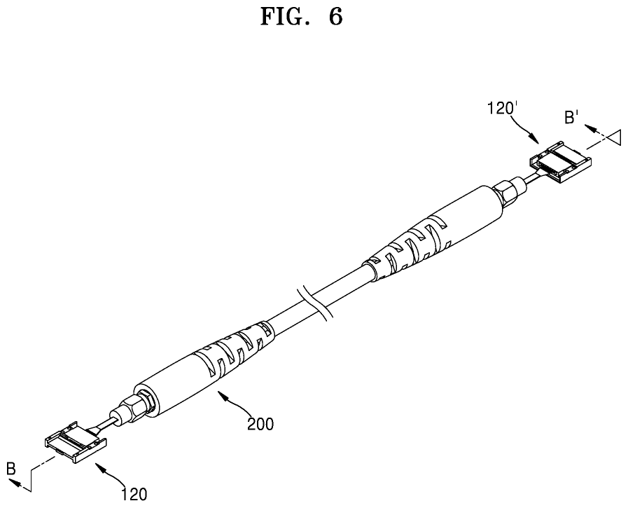

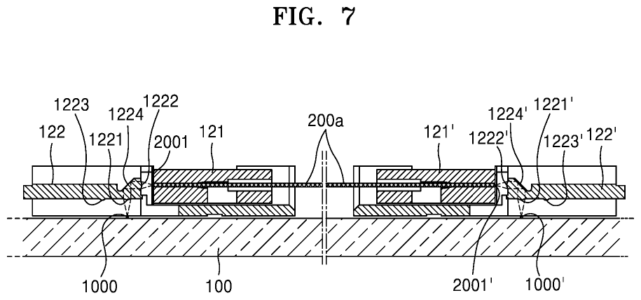

Hereinafter, with reference to FIGS. 6 and 7, an active optical cable according to another embodiment of the present invention is described. For the configuration of an active optical cable not shown in FIGS. 6 and 7, FIGS. 1 to 5 may be referred to.

FIG. 6 is a diagram showing one optical engine and another optical engine formed at both ends of an optical cable portion according to an embodiment of the present invention. FIG. 7 is a diagram showing a B-B′ cross section and C-C′ cross section of FIG. 6.

According to this embodiment, one PCB portion 100 and another PCB portion 100′ may be arranged on both sides of the optical cable portion 200. That is, one optical engine 120 and the other optical engine 120′ may be disposed on two PCB portions disposed on both sides of the optical cable portion 200, respectively.

In this case, when the optical element 1000 of one PCB portion 100 is a light emitting portion, the optical element 1000′ of another PCB portion 100′ may be a light receiving portion. Conversely, when the optical element 1000 of one PCB portion 100 is a light receiving portion, the optical element 1000′ of another PCB portion 100′ may be a light emitting portion.

As an example, a case where the optical element 1000 of one PCB portion 100 is a light emitting portion is described. The PCB portions 100 and 100′ are respectively connected to both ends of the optical cable portion, and the optical engines 120 and 120′ are respectively connected to both ends of the plurality of optical fibers 200a. In this case, the light emitted through the optical element 1000 of one PCB portion 100 may pass through one optical engine 120 to pass through from one end to the other end of the plurality of optical fibers 200a, and the light passing through the other end of the plurality of optical fibers 200a may pass through the other optical engine 120′ to be received through an optical element 1000′ of the other PCB portion 100′.

The light emitted through one optical element 1000 may sequentially pass through one first lens 1221, one mirror-inclined plate 1224, and one second lens 1222 to be condensed onto one end of the plurality of optical fibers 200a. In addition, the light condensed at one end of the plurality of optical fibers 200a may move to the other end of the plurality of optical fibers 200a, and the light moving to the other end of the plurality of optical fibers 200a may sequentially pass through the other second lens 1222′, the other mirror-inclined plate 1224′, and the other first lens 1221′ and be received by an optical element of the other PCB portion 100′.

As another example, a case where the optical element 1000′ of another PCB portion 100′ is a light emitting portion is described.

The light emitted through the optical element 1000′ of the other PCB portion 100′ may pass through the other optical engine 120′ and from the other end to one end of the plurality of optical fibers 200a. And then, the light passing through one end of the plurality of optical fibers 200a may pass through an optical engine 120 and be received through an optical element 1000 of a PCB portion 100.

The light emitted through the other optical element 1000′ may sequentially pass through the other first lens 1221′, the other mirror-inclined plate 1224′, and the other second lens 1222′ and be condensed onto the other end of the plurality of optical fibers 200a. In addition, the light condensed at the other end of the plurality of optical fibers 200a may move to one end of the plurality of optical fibers 200a, and the light moving to one end of the plurality of optical fibers 200a may sequentially pass through the second lens 1222, the mirror-inclined plate 1224, and the first lens 1221 to be received by the optical element 1000 of a PCB portion 100.

The active optical cable according to an embodiment of the present invention may protect the optical element from external physical shock through a structure in which the optical engine covers the optical element formed in the PCB portion.

In addition, the active optical cable according to an embodiment of the present invention employs a mirror-inclined plate that reflects light by a 90-degree angle for a compact optical engine structure.

In addition, the active optical cable according to an embodiment of the present invention has a structure in which a plurality of optical fibers penetrate inside the optical fiber connector, so that the plurality of optical fibers are located inside the optical fiber connector and may be protected from external physical shock.

In addition, the active optical cable according to an embodiment of the present invention may improve the durability of the optical engine and minimize alignment errors between the plurality of optical fibers and the lens structure of the main body through a coupling structure between the protruding portion of the main body and the recessed portion of the optical fiber connector.

In addition, the active optical cable according to an embodiment of the present invention can minimize the alignment error between the lens structure of the optical engine and the optical element structure of the PCB portion through the pivot mark formed at the lower end of the main body.

The effects of the present invention are not limited to the effects mentioned above, and other effects not mentioned are clearly understood by those skilled in the art from the description of the claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An active optical cable comprising:
a PCB portion connected to an optical cable portion;
an optical engine coupled to the PCB portion; and
a plurality of optical fibers extending from the optical cable portion,
wherein the optical engine is connected to the plurality of optical fibers, and
the plurality of optical fibers are inserted and combined inside the optical engine.

2. The active optical cable of claim 1, wherein the optical engine is formed to cover an optical element formed on the PCB portion.

3. The active optical cable of claim 1,
wherein the optical engine comprises a first lens that condenses light emitted from an optical element;
a mirror-inclined plate that reflects light that passed through the first lens; and
a second lens that condenses light reflected by the mirror-inclined plate.

4. The active optical cable of claim 3, wherein the light condensed by the second lens passes through the optical fiber through an optical fiber end.

5. The active optical cable of claim 3, wherein the mirror-inclined plate bends a path of light passing through the first lens by a 90-degree angle.

6. The active optical cable of claim 3,
wherein the optical engine includes
an optical fiber connector connected to the plurality of optical fibers; and
a main body coupled to the optical fiber connector, and
the first lens and the second lens are disposed on the main body.

7. The active optical cable of claim 3,
wherein the optical engine includes
an optical fiber connector connected to the plurality of optical fibers; and
a main body coupled to the optical fiber connector,
wherein a plurality of hole portions are formed in the optical fiber connector,
the plurality of hole portions are arranged in a row in a first direction, and
the second lenses are formed in plural numbers and arranged in a row at positions corresponding to each of the plurality of hole portions arranged in a row.

8. The active optical cable of claim 7,
wherein the plurality of second lenses are arranged in a row in the first direction, and
the first lenses are formed in plural numbers and are arranged in a row at a position corresponding to each of the plurality of second lenses arranged in a row at an angle of 90 degrees with respect to the mirror-inclined plate.

9. The active optical cable of claim 8,
wherein the plurality of first lenses are arranged in a row in the first direction,
an optical element is formed on the PCB portion, and
the optical elements are formed in plural numbers and arranged in a row at positions corresponding to each of the plurality of first lenses arranged in a row.

10. The active optical cable of claim 3, wherein a magnification ratio of the first lens to the second lens is 1:1 to 1:2.

11. The active optical cable of claim 1,
wherein the optical engine comprises
an optical fiber connector connected to the plurality of optical fibers; and
a main body coupled to the optical fiber connector,
a plurality of hole portions are formed in the optical fiber connector,
the plurality of optical fibers pass through the plurality of hole portions and are connected to the optical fiber connector.

12. The active optical cable of claim 11,
wherein recessed portions are formed in the optical fiber connector,
protruding portions are formed in the main body, and
the protruding portions are respectively inserted in and coupled to the recessed portions.

13. The active optical cable of claim 12,
wherein the protruding portions are disposed on both sides of the plurality of holes with the plurality of holes positioned between the two protruding portions,
the two recessed portions are disposed at positions corresponding to the protruding portions, and
the two protruding portions are respectively inserted in and coupled to the two recessed portions.

14. The active optical cable of claim 12, wherein an end of the protruding portion end is formed in a hemispherical shape.

15. The active optical cable of claim 11, wherein a pivot mark is formed at a lower end of the main body.

16. The active optical cable of claim 1,
wherein the PCB portion is connected to both ends of the optical cable portion,
the optical engine is connected to both ends of the plurality of optical fibers,
light emitted through an optical element of the PCB portion passes through one optical engine and passes from one end to the other end of the plurality of optical fibers, and light passing through the other end of the plurality of optical fibers passes through the other optical engine and is received through the optical element of the other PCB portion.

17. The active optical cable of claim 16, wherein the light emitted through the optical element sequentially passes through a first lens, a mirror-inclined plate, and a second lens and is condensed on one end of the plurality of optical fibers.

18. The active optical cable of claim 17,
wherein the light condensed to one end of the plurality of optical fibers moves to the other end of the plurality of optical fibers, and
the light moving to the other end of the plurality of optical fibers sequentially passes through the other second lens, the other mirror-inclined plate, and the other first lens and is received by the optical element of the other PCB portion.
